(19) United States
(12) Patent Application Publication
(10) Pub. No.: US 2025/0306882 A1
(43) Pub. Date: Oct. 2, 2025

(54) SYSTEMS AND METHODS FOR ITERATIVE FEEDBACK-DRIVEN CODE SYNTHESIS USING SYNTAX TREES AND LARGE LANGUAGE MODELS

(71) Applicant: UST Global Inc, Aliso Viejo, CA (US)

(72) Inventors: Alla Abdella, Aliso Viejo, CA (US); Adnan Masood, Temple Terrace, FL (US); Richard Muirhead, Aliso Viejo, CA (US)

(21) Appl. No.: 19/094,039

(22) Filed: Mar. 28, 2025

Related U.S. Application Data
(60) Provisional application No. 63/571,184, filed on Mar. 28, 2024.

(51) Int. Cl. G06F 8/41; G06F 8/51

(52) U.S. Cl. CPC G06F 8/447; G06F 8/42; G06F 8/433; G06F 8/51

(57) ABSTRACT

A system for translating source code in a first programming language to a target language is provided. The system is configured to receive source code for converting to target code; determine an abstract syntax tree from the source code; determine program specifications from the source code; determine a dependency graph from the source code; determine a plurality of chunks based at least in part on the abstract syntax tree, the program specifications, and the dependency graph; determine a plurality of converted chunks based at least in part on the plurality of chunks and a deep learning model, the deep learning model converting the plurality of chunks from the language of the source code to the language of the target code; post-process the plurality of converted chunks to obtain intermediate code; and provide the intermediate code as the target code.

### CROSS-REFERENCE TO RELATED APPLICATIONS

This application claims the benefit of and priority to U.S. Provisional Application No. 63/571,184, filed Mar. 28, 2024, which is hereby incorporated by reference herein in its entirety.

### FIELD

The present invention relates generally to code generation systems, and more specifically, to computing systems and methods for using syntax trees and large language models to synthesize, generate, or translate source code written in a source language to target code written in a target language.

### BACKGROUND

Early attempts of translating code from one language to another were largely manual, time-consuming and error-prone, leading to the development of automated tools. In software development, the automatic generation of code from specifications or the translation of code between programming languages has been fraught with challenges. The initial phase of automated translation focused on direct syntax conversion, often termed “source-to-source” translation. These tools parsed source code into an intermediate representation, which was then used to generate code in the target language. This approach frequently struggled with idiomatic constructs and semantic discrepancies between languages, leading to functionally incorrect or suboptimal translations.

As programming languages evolved, so did the complexity of code translation tasks. One significant challenge was maintaining the functional integrity and performance characteristics of the original code, especially when translating between languages with different paradigms (e.g., procedural to object-oriented). Another challenge was handling context-sensitive information, such as variable scoping and type inference, which are not always explicitly defined in the source code but crucial for accurate translation.

Traditional methods often produce code that contains inaccuracies, hallucinations, and inefficiencies. Traditional methods render the use of automatically generated code largely unusable. The present disclosure is directed at solving at least some of the aforementioned problems with automatically generated code.

### SUMMARY

According to some implementations of the present disclosure, a system is provided. The system includes one or more data processors and a non-transitory computer-readable storage medium containing instructions. When the instructions are executed on the one or more data processors, the one or more data processors perform operations that include receiving source code for converting to target code. The language of the source code is different from language of the target code. The operations further include determining an abstract syntax tree from the source code, determining program specifications from the source code, determining a dependency graph from the source code, determining a plurality of chunks based at least in part on the abstract syntax tree, the program specifications, and the dependency graph, and determining a plurality of converted chunks based at least in part on the plurality of chunks and a deep learning model. The deep learning model converts the plurality of chunks from the language of the source code to the language of the target code. The operations further include post-processing the plurality of converted chunks to obtain intermediate code and providing the intermediate code as the target code.

According to some implementations of the present disclosure, a method includes receiving source code for converting to target code. A programming language of the source code is different from a programming language of the target code. An abstract syntax tree is determined from the source code. Program specifications are determined from the source code. A dependency graph is determined from the source code. A plurality of chunks is determined based at least in part on the abstract syntax tree, the program specifications, and the dependency graph. A plurality of converted chunks is determined based at least in part on the plurality of chunks and a deep learning model. The deep learning model converts the plurality of chunks from the programming language of the source code to the programming language of the target code to obtain the plurality of converted chunks. The plurality of converted chunks is post-processed to obtain intermediate code. The intermediate code is provided as the target code. Providing the target code can involve sending the target code to a client device or storing the target code in a repository or database.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 illustrates a block diagram of a system for code translation using a large language model, according to certain aspects of the present disclosure.

FIG. 2 is a flow diagram of a process for translating code from a source code to a target code, according to certain aspects of the present disclosure.

FIG. 3 is another flow diagram of a process for translating code from a source code to a target code, according to certain aspects of the present disclosure.

FIG. 4 is an algorithm for language conversion, according to certain aspects of the present disclosure.

### DETAILED DESCRIPTION

Deep learning models and in particular, the advent of large language models (LLMs) and generative artificial intelligence (AI) has heralded a new era in automating complex software tasks. Traditional methods of translating code between languages and analyzing dependencies in large codebases, while crucial, are notoriously labor-intensive. Leveraging the transformative capabilities of deep learning and LLMs, the present disclosure provides automated, scalable solutions to efficiently address these challenges. Significant strides in this domain have been made through the development of models or transformers like GPT-3 and its successors, which showcase the vast potential of LLMs in understanding and generating human-like text. The success of these models in natural language processing has paved the way for their application in other complex tasks like code translation and dependency analysis.

Embodiments of the present disclosure provide systems and methods that employ LLMs for accurate code translation between programming languages, preserving the original code's functionality. Embodiments of the present disclosure incorporate code chunking, summarization, and LLM-integrated translation to ensure high fidelity in the translated code. Embodiments of the present disclosure construct precise dependency graphs for large-scale software projects. By leveraging abstract syntax trees and advanced graph algorithms, embodiments of the present disclosure adeptly map complex, multi-faceted dependencies between diverse program elements, providing an unprecedented level of understanding of intricate software architectures. Embodiments of the present disclosure offer a paradigm shift in software development, drastically streamlining critical workflows, reducing manual efforts, and enhancing productivity. The present disclosure provides details that build on the foundational work in the field of deep learning and its remarkable progress over the last

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

Prior code translation approaches include rule-based approaches, syntax-directed technique, and machine translation approaches. In rule-based approaches a set of predefined syntactic rules were used to map constructs from the source to the target language. Tools like J2EE and EJB were popular for specific language pairs (e.g., Java to C#). However, these systems often failed to capture semantic nuances and were limited to a narrow range of language pairs, making them less flexible for diverse coding environments. Syntax-directed techniques are used in compilers like GCC and LLVM and involve translating code constructs based on their syntax tree representations. Although effective for certain language pairs, they are inherently constrained by the need for extensive rule sets for each language pair and struggle with idiomatic expressions and high-level semantic conversions. Machine translation approaches include projects like CodeBERT and TransCoder which leverage neural networks to understand and translate code. Machine translation approaches often require large parallel corpora of source and target language code for training, and availability of such material can be scarce or unavailable for certain languages.

The introduction of machine learning and, more recently, LLMs has marked a paradigm shift in code translation methodologies. Unlike traditional rule-based systems, LLMs can learn from vast corpora of source code, enabling them to grasp not just the syntax but also the contextual and semantic nuances of different programming languages. This capability allows for a more intelligent and context-aware translation process, addressing many of the limitations inherent in earlier methods.

Despite these advances, challenges remain. Ensuring that translated code adheres to the best practices and conventions of the target language, and maintaining the efficiency and readability of the code, are ongoing concerns. Furthermore, the intricate intricacies of legacy systems, which often contain undocumented features or behaviors, pose a significant hurdle.

Embodiments of the present disclosure improve upon traditional systems by iteratively refining code translations to obtain the target code. In some implementations, using a human-in-the-loop can further enhance code translation accuracy and reliability of the code translation system.

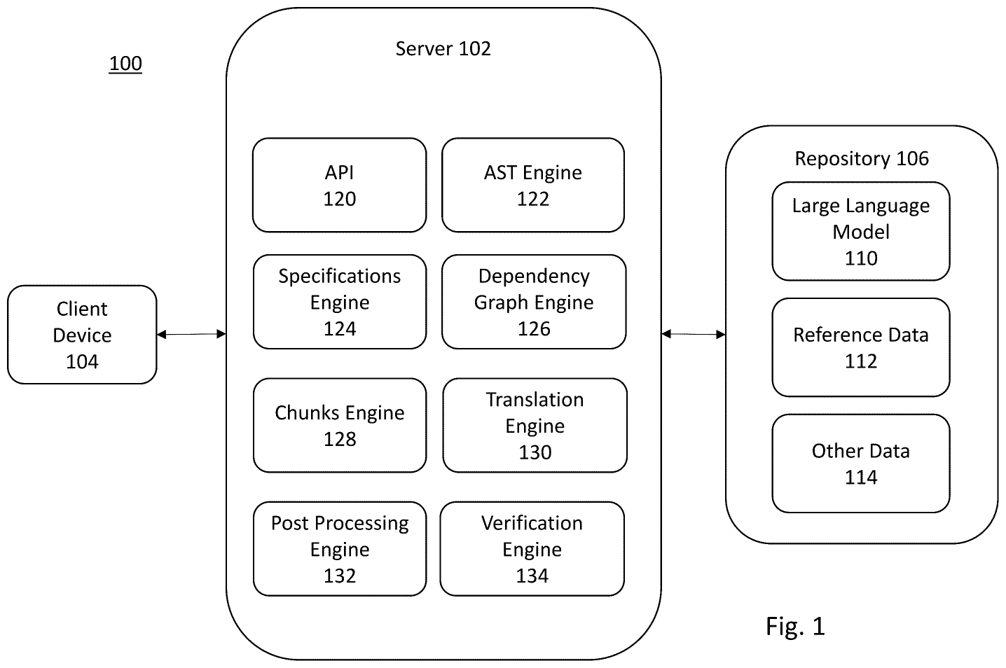

Referring to FIG. 1, a system 100 for code translation of source code to target code using a large language model 110 is provided, according to certain aspects of the present disclosure. The system 100 includes a server 102, a client device 104, and one or more repositories 106 for storing information. The server 102 and the client device 104 are computing devices with at least one processor, memory, storage device, and network interface. Examples of the client device 104 include a laptop computer, a desktop computer, a smart phone, a tablet, a phablet, a personal digital assistant (PDA), a smart television, etc. The server 102 can include one or more computing devices to perform functions described in the present disclosure.

The one or more repositories 106 can store a deep learning model, language model or large language model 110, reference data 112, or other data 114. The one or more repositories 106 can store intermediate calculations and other data used by the server 102. The one or more repositories 106 can be housed at a separate location from the server 102 and/or owned by a different entity than the server 102. The server 102 can include multiple computing devices, networked across different physical locations, for example, by using the Internet. In some implementations, computing device(s) can host a chat interface or can receive requests via application programming interfaces for interacting with the large language model 110.

The server 102 is configured to receive requests from the client device 104. In some implementations, the requests include source code or files associated with the source code, information pertaining to the source code (e.g., a specific language associated with the source code, locations for repositories where grammar files associated with the source code is located, language-specific knowledge provided in a technical domain document, etc.), a target language (or multiple target languages), model-related information (e.g., model hyperparameters, context limit, etc.), prompt modification, information pertaining to the translation algorithm (e.g., adjustments to a context limit, a number of feedback iterations, etc.), settings associated with databases or storage, any feedback included for the model, conversational engagement with the model, review request to the model against certain standards, information pertaining to the target language, information pertaining to output format of the target code, or any combination thereof. Examples of programming languages include COBOL, Java, C#, C++, BTEQ, PySpark, etc. In some implementations, the server 102 stores some information in the received requests in the repository 106.

In some implementations, the reference data 112 is the same as or similar to some information received in the requests by the client device 104. That is, some of the information received from the client device 104 can be stored as the reference data 112. For example, if the client device 104 provides a grammar file for a specific language, the grammar file can be stored in the reference data 112. In another example, if the client device 104 provides a link to a depository that contains the grammar file, then the server 102 can download the grammar file and store the grammar file in the reference data 112.

In some implementations, the reference data 112 includes information for training the large language model 110. Any large language model can be used in embodiments of the present disclosure. Example of large language models include any version of generative pretrained transformer (GPT), large language model meta AI (LLaMA), Google Gemini, Google pathways language model (PaLM), Microsoft Orca, etc. In some implementations, the reference data 112 includes information for priming the large language model 110. For example, a series of prompts can be provided to the large language model 110 to explain what a conversion process entails. The exact sequence and wording that should be provided in the prompts can be included in the reference data. In some implementations, subject matter experts can provide diverse feedback in various human-like formats, without restrictions. The model can be instructed to execute multiple steps and concatenate these actions to perform the conversion.

In some implementations, a user of the client device 104 can perform a final analysis of the target code provided by the server 102. The user of the client device 104 can provide feedback to the server 102. The feedback can be stored as other data 114 or as reference data 112.

The server 102 includes an application programming interface (API) 120, an abstract syntax tree (AST) engine 122, a specifications engine 124, a dependency graph engine 126, a chunks engine 128, a translation engine 130, a post processing engine 132, and a verification engine 134. Each of the API 120, the AST engine 122, the specifications engine 124, the dependency graph engine 126, the chunks engine 128, the translation engine 130, the post processing engine 132, and the verification engine 134 identified in FIG. 1 is a combination of hardware and software configured to perform specific functionality as described in the following paragraphs.

The API 120 of the server 102 facilitates communication between the client device 104 and the server 102. In some implementations, the API 120 also facilitates communication between the server 102 and the one or more repositories 106. The API 120 packages data packets to (and from) the client device 104, so that there is a bidirectional information flow between the server 102 and the client device 104. The API 120 can package information (e.g., feedback data, reference data, source code, etc.) received from the client device 104 so that these provided information can be processed by the server 102. In some implementations, the API 120 is a web service compatible with hypertext transfer protocol (HTTP) and machine-readable file formats such as extensible markup language (XML) and JavaScript object notation (JSON).

The AST engine 122 of the server 102 is configured to determine an abstract syntax tree from the source code (e.g., source code received from the client device 104 or stored in the repository 106). An abstract syntax tree is a data structure used in compilers to represent structure of a program code. The abstract syntax tree abstracts away the syntactic details of the program code, focusing on its syntactic structure. Each node of the tree denotes a construct occurring in the program code. The AST engine 122 generates the abstract syntax tree by parsing the source code and organizing syntactical structures of the source code into a tree-like format. Each node of the tree-like format represents a different “abstract” syntactic structure of the program.

In some implementations, the AST engine 122 parses the source code using lexical analysis. Lexical analysis involves breaking down the source code into tokens based on the lexical grammar, such as keywords, identifiers, and literals. In some implementations, the AST engine 122 performs syntactic analysis. For example, a parser that understands C grammar organizes the tokens from the lexical analysis into a parse tree or abstract syntax tree, reflecting the program's hierarchical syntactic structure. The AST engine 122 can utilize tools such as ANTLR, Bison, Yacc, or bespoke parsers for parsing a given grammar when converting the source code to abstract syntax trees. The AST engine 122 can use parsers to effectively convert the source code into a navigable abstract syntax tree.

The specifications engine 124 of the server 102 is configured to generate program specification from the source code. Program specifications describe intended behavior, outputs, and side effects of a program. Program specifications are formal descriptions of what a program should do. Program specifications can include function requirements, performance criteria, and constraints. The specifications engine 124 generates the program specification by analyzing the source code to understand functionality of the source code, purpose of the source code, and expected behavior when the source code is executed. In some implementations, running time and resource use of the source code is included in the specification. In some implementations, because target code should behave identically to the source code when executed, the program specifications define functionality and behavior that the target code should exhibit.

In some implementations, function requirements, performance criteria, and constraints include functionalities and missing elements. For example, functionalities involve ensuring that all the functions and features present in the source code are also present and work in the same way in the target code. Capabilities of the original program are not lost or altered during the translation from source code to target code. In some implementations, the functionalities metric does not just cover the main features but also includes the minor functionalities that might affect user experience or the outcome of the program. In a second example, missing elements are some elements from the source code that may not be directly translatable to the target language due to language-specific features or limitations during the translation process. The missing elements metric identifies such gaps or missing elements. Missing elements help in determining whether additional workarounds or redesigns are needed to achieve full functionality in the target code.

The dependency graph engine 126 of the server 102 is configured to generate a dependency graph from the source code (and/or from the abstract syntax tree of the AST engine 122). The dependency graph is a representation of how different parts of a program depend on each other. The dependency graph maps out relationships and dependencies between various functional elements with the software, such as classes, functions, variables, and other entities. Understanding these dependencies help in maintaining the integrity and functionality of the generated code during the code synthesis process.

In some implementations, the dependency graph engine 126 performs a static analysis on the source code to extract the dependency graph. Static analysis is effective for identifying syntactic dependencies but can be limiting in detecting runtime dependencies. Additionally, accuracy of dependency graphs generated via static analysis can suffer when used on dynamic languages or complex architectures. Complex architectures include comprehensive repository for enterprise (and/or startups) that encompass front-end, back-end, and database integration. In some implementations, the dependency graph engine 126 performs a dynamic analysis. Dynamic analysis involves monitoring program execution to map dependencies. Dynamic analysis can be more involved due to setting up representative execution environments and added overhead of monitoring the runtime behavior of the program.

In some implementations, the dependency graph engine 126 performs static analysis on the source code while also using dynamic behavior to inform organization of the dependency graph. By constructing comprehensive dependency graphs and employing advanced graph algorithms, embodiments of the present disclosure provide a more nuanced understanding of both compile-time and runtime dependencies. This holistic view is particularly crucial for modern, complex software architectures where traditional static or dynamic methods fall short. Example tools for dependency analysis include SonarQube, Understand, DTrace, Valgrind, etc.

The dependency graph engine 126 can construct the dependency graph in a methodical way. This provides an advantage for large-scale software projects that can have a complex web of dependencies and relationships between program components such as variables, classes, and functions. By using grammar files associated with a language, the dependency graph engine 126 can construct dependency graphs for any language. The grammar files of the language can be used to understand logical segments of the language.

In some implementations, the dependency graph engine 126 commences by transforming source code into an abstract syntax tree representation that adheres to the source code's specific language grammar. Program elements—such as functions, classes, and variables—are mapped to nodes, with dependencies like calls and inheritance modeled as directed edges. This method allows a comprehensive program graph. For example, to map nodes in the dependency graph, the abstract syntax tree is traversed to pinpoint items in the abstract syntax tree corresponding to key program elements like variables, functions, and classes as nodes in the dependency graph. Through detailed examination of the abstract syntax tree, dependencies are mapped out among the identified nodes. The dependencies are mapped out using edges between the identified nodes. For instance, a dependency is marked by an edge from node A to node B if A utilizes or references B.

Dependency graphs provide the server 102 different insights to the source code. For example, intricacies associated with the dependency graph can be explored using a depth-first search and breath-first search. For example, depth-first search delves deep into dependency analysis, and breath-first search sheds light on broader dependency structure across the program. These strategies can aid in cycle detection and assessing the ripple effects of modifications within the source code (or software program). These exploration strategies can also expose strongly connected components and intricate dependency motifs that may be obscured in the original codebase.

In some implementations, the server 102 can employ topological sorting on the dependency graph to achieve a linear sequence. This ensures that each node (e.g., program element A) precedes any node (B) that depends on it. This topological sorting can later establish a logical compilation or execution order. An advantage to this strategy is that it facilitates a logical order for file or module compilation. This advantage can be important for efficiently managing complexity in large-scale software projects. The dependency graph engine 126 can topologically sort the nodes of the dependency graph to ensure individual units are processed only after resolving requisites, thus maintaining correctness when linear synchronization is required.

The chunks engine 128 of the server 102 is configured to divide the source code into coherent, logically distinct blocks or chunks. The chunks engine 128 uses information obtained from the AST engine 122 (e.g., the abstract syntax tree), the specifications engine 124 (e.g., program specification), and/or the dependency graph engine 126 (e.g., the dependency graph) to segment the source code. The source code can be segmented based on functionality, purpose, and interdependencies. Each chunk represents a self-contained piece of the program that can be synthesized, modified, or translated independently while maintaining the overall program logic and functionality. The chunks engine 128 iterates over the source code to create logical chunks that ensure the entire codebase is analyzed and processed. Iteration over the source code is comprehensive and can greatly improve accuracy and completeness of the code synthesis process when generating the target code.

In some implementations, creating logical chunks from a program using the programming language grammar involves a detailed parsing process of the source code to identify syntactic structures corresponding to different programming constructs. These constructs, defined by the grammar's rules, describe how the language elements combine to form valid program statements.

Different granularities of logical chunks will be explored based on type of language. In one case, logical chunks can be grouped by functions. In C, functions are identified by the functionDefinition rule in C. The functionDefinition rule outlines the structure of a function declaration, including various elements like declaration specifiers, declarators, and the compound statement forming the function body. In another case, logical chunks can be grouped by classes. While C, as a procedural language, does not support classes, in object-oriented languages, class constructs are identified by specific grammar rules. These grammar rules define the syntax for class declaration, including elements like class name, members, and methods. In another case, logical chunks can be grouped by loops. For example, constructs such as for, while, and do-while loops are identifiable in C through rules like iterationStatement, defining the syntax for these looping statements. In another case, logical chunks can be grouped by files. For example, in C, a file is represented by a compilationUnit, which consists of one or more translationUnits, encompassing the entire content of a C source file.

In some implementation, the chunks engine 128 traverses the abstract syntax tree obtained from the AST engine 122. The abstract syntax tree is then navigated to identify nodes corresponding to desired programming constructs. The abstract syntax tree can be navigated or traversed using depth-first or breadth-first search strategies. In some implementations, any search strategy can be employed for traversing the abstract syntax tree (e.g., custom analysis scripts or programs that apply logic to identify and extract chucks based on grammar rules can be employed, such as locating all functionDefinition nodes). When the nodes corresponding to the desired programming constructs are reached, these nodes and their subtrees are extracted. These nodes and their subtrees represent logical chunks of the program. In C, an example of a node of interest is functionDefinition. Thus, a functionDefinition node and corresponding subtrees can represent a logical chunk of the source code (or the program).

In some implementations, the desired programming constructs or nodes are identified a priori based on the specific code chunking strategy employed. This allows the chunks engine 128 to efficiently traverse the abstract syntax tree and extract the relevant nodes and subtrees corresponding to the pre-defined constructs of interest, such as functions, classes, loops, or files. By specifying these constructs beforehand, the chunking process can be optimized to focus on the most meaningful and logical code segments, ensuring consistency and maintainability of the generated target code.

The translation engine 130 of the server 102 is configured to use the large language model 110 to convert the logical chunks and/or other elements derived from the abstract syntax tree, program specifications, and dependency graph into corresponding code segments in the target language or format. Large language models, with their advanced understanding and generation capabilities, can produce human-like text based on input provided to them. The logical chunks and/or the other elements are provided as inputs to large language model 110 to obtain the code segments in the target language or format. These code segments are also referred to herein as converted chunks. Embodiments of the present disclosure combine abstract syntax trees, program specifications, dependency graphs, and logical chunking with large language models to enhance accuracy, efficiency, and reliability of automated code synthesis. Embodiments of the present disclosure are adaptable to various large language models and are thus model agnostic. Embodiments of the present disclosure have a problem-solving orientation, addressing specific challenges in code generation.

The post processing engine 132 of the server 102 is configured to combine the code segments (i.e., converted chunks) into cohesive code blocks. The post processing engine 132 deduplicates and ensures that the combined code maintains the integrity and functionality of the original source code. In the present disclosure, the post processing engine 132 provides as output intermediate code. The intermediate code is in the target language.

The verification engine 134 of the server 102 is configured to perform various tests on the intermediate code to assess accuracy and/or functionality of the intermediate code. For example, the verification engine 134 can compile the intermediate code to determine whether there are any compile-time errors or warnings. In some implementations, the verification engine 134 is configured to execute the intermediate code to obtain an output. The output can be compared with an expected output. For example, the verification engine 134 can compile and run the source code to obtain the expected output, and the output from executing the intermediate code is compared with the expected output. The verification engine 134 is configured to obtain feedback and provide the feedback to the translation engine 130 for updating the large language model 110 and/or updating a future prompt provided to the large language model 110. The feedback provided includes any compiler errors, any compiler warnings, any artifacts observed in the output, any run-time errors, any deviation of the output from the expected output (e.g., different numerical results printed, different variable states present in both outputs, etc.).

A feedback loop involving the translation engine 130, the post processing engine 132, and the verification engine 134 can be used to fine-tune the intermediate code to eliminate negative results in the output of the verification engine 134. The feedback loop is an automated loop fine-tuning the intermediate code such that the expected output and the output match or some iteration or loop threshold is reached. The feedback loop and iterating over this feedback loop enhances the quality and/or accuracy of the intermediate code over time. In some implementations, if the iteration or loop threshold is reached, then a copilot mode is activated. In the copilot mode, the client device 104 provides input on how to change the intermediate code. The input can be incorporated in a next prompt provided to the translation engine 130.

A problem can be formulated where source code [symbol] is written in a programming language that needs to be translated into a target programming language. The goal is to develop an algorithm that can automatically translate the source code [symbol] into the target code [symbol] while preserving the functionality of the original code.

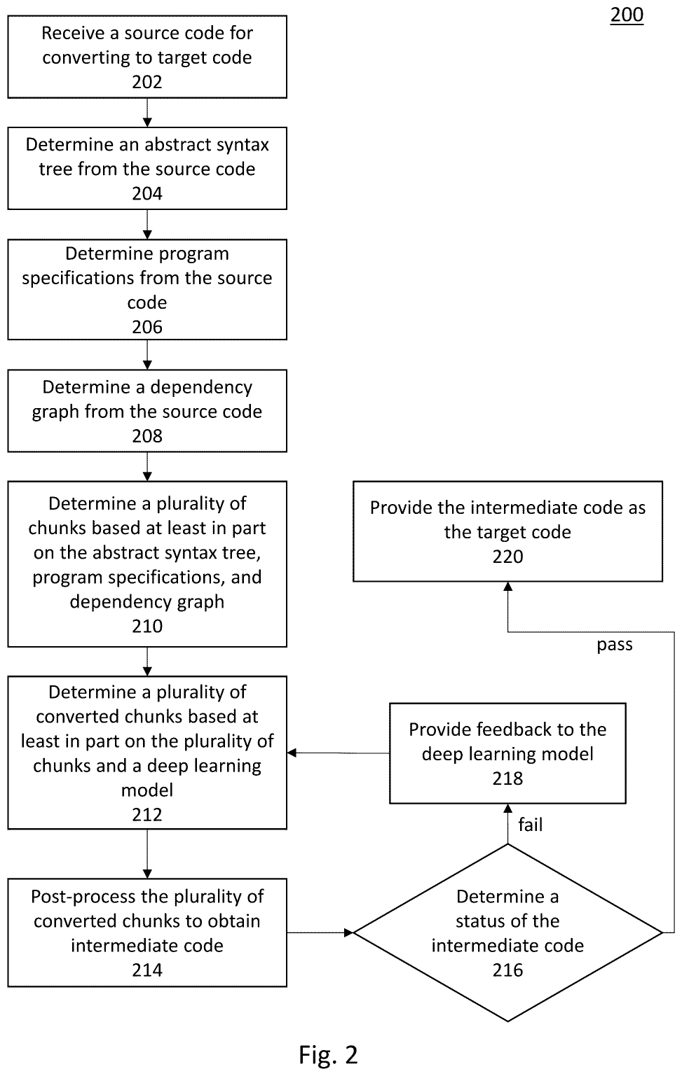

Referring to FIG. 2, a process 200 for translating code from a source code to a target code, according to certain aspects of the present disclosure. The process 200 is performed by the server 102. At step 202, the server 102 receives source code for converting to target code. In some implementations, the source code is written in a language different from a target language of the target code. In some implementations, the source code is written in a programming language that is the same as the target language of the target code such that the target code is optimized and reviewed against predefined or custom standards of the programming language.

In some implementations, the source code [symbol] is divided into multiple files, for example, divided into a set of sub-documents [symbol] ={d₁, d₂, . . . , dₘ}, where each sub-document dᵢ can further be divided into a set of chunks [symbol] ᵢ={c_{i,1}, c_{i,2}, . . . c_{i,n}_{ᵢ}}. In some implementations, the API 120 of the server 102 receives the source code [symbol] from the client device 104 and/or the repository 106.

At step 204, the AST engine 122 of the server 102 determines an abstract syntax tree from the source code [symbol] .

At step 206, the specifications engine 124 of the server 102 determines program specifications from the source code 206. In some implementations, the specifications engine 124 summarizes the sub-documents [symbol] of the source code [symbol] . In some implementations, the summarization is performed using an LLM. In some implementations, the program specifications are included in comments embedded in the source code 206.

At step 208, the dependency graph engine 126 of the server 102 determines a dependency graph from the source code 208.

At step 210, the chunks engine 128 of the server 102 determines a plurality of chunks [symbol] based at least in part on the abstract syntax tree of step 204, the program specifications of step 206, and the dependency graph of step 208.

In some implementations, the set of chunks [symbol] ᵢ is determined for each sub-document dᵢ. In some implementations, the chunks engine 128 uses the large language model 110 to generate summaries for each sub-document dᵢ. Each sub-document summary sᵢ is a verbal description of what is included in the sub-document dᵢ. In some implementations, the chunks engine 128 aggregates all sub-document summaries S={s₁, s₂, . . . , sₘ} to obtain an aggregate summary S_{agg}=∪ᵢ₌₁^{m}sᵢ. In some implementations, the specifications engine 124 performs the summarizing and aggregation of sub-document summaries.

In some implementations, the chunks engine 128 uses the large language model 110 to generate summaries for each of the determined chunks in the plurality of chunks [symbol] . Each chunk summary s_{i,j} is a verbal description of what is included in the chunk c_{i,j} found in the sub-document dᵢ. In some implementations, the aggregate summary S_{agg} is used to summarize each chunk c_{i,j} into each chunk summary s_{i,j}.

At step 212, the translation engine 130 of the server 102 uses the large language model 110 to determine a plurality of converted chunks. In some implementations, the plurality of chunks [symbol] is converted iteratively one chunk at a time. Each chunk c_{i,j} is converted into the target language considering system/user prompts P and the abstract syntax tree T. The items are concatenated chunk-wise where R=PβTβS_{agg}βc_{i,j}, and β denotes concatenation.

In some implementations, neighboring chunks have associated weights, for example, a neighboring chunk c_{i,j} has a weight w_{i,j,k}. In some implementations, the weight w_{i,j,k} can be used to adjust whether a summary associated with a chunk c_{i,j} is included in the aggregate summary S_{agg}. For example, the aggregate summary S_{agg} can be represented as Σ_{k≠j} w_{i,j,k}·s_{i,j} with chunk c_{i,j} representing the chunk being converted. This way, the aggregate summary S_{agg} can be generated iteratively as the different chunks are converted iteratively. In some implementations by choosing weight w_{i,j,k}=0, chunk summary s_{i,j} is not included in the aggregate summary S_{agg}. This can be advantageous in cases where a chunk is of low complexity, for example, a simple for loop. This can improve readability of the target code and/or an accompanying specification document accompanying the target code by avoiding extraneous or over-explanatory comments.

At step 214, the post processing engine 132 performs post-processing on the plurality of converted chunks to obtain the intermediate code. In some implementations, the plurality of converted chunks is aggregated to obtain the intermediate code. The intermediate code [symbol] is obtained by aggregating all translated chunks in a set of translated chunks [symbol] ᵢ={t_{i,1}, t_{i,2}, . . . t_{i,n}_{ᵢ}} for each sub-document dᵢ. The intermediate code [symbol] can be written as ∪ᵢ₌₁^{m} [symbol] ᵢ.

In some implementations, the intermediate code [symbol] is cleaned up using technical domain documents (TDD) and/or the abstract syntax tree. The technical domain documents and/or the abstract syntax tree along with the intermediate code [symbol] are provided to the large language model 110 to refine and clean the intermediate code [symbol] . In some implementations, the aggregate summary S_{agg} can be dispersed throughout the intermediate code [symbol] as comments to help with readability of the intermediate code [symbol] . As discussed above, each chunk summary s_{i,j} can accompany its respective position in the intermediate code [symbol] based on weight w_{i,j,k}. In some implementations, the aggregate summary is S_{agg} is provided as a separate “readme” file.

At step 216, the verification engine 134 determines a status of the intermediate code [symbol] . The status of the intermediate code [symbol] can include a fail status or a pass status. A fail status can include error such as compile errors, runtime errors, output comparison not matching an expected output, or any combination thereof. In some implementations, in a fail status, the verification engine 134 provides feedback to the large language model 110 at step 218. With the feedback provided to the large language model 110, the server 102 performs step 212 again using the provided feedback and the plurality of chunks of step 210 to determine a new plurality of converted chunks. The provided feedback can be incorporated in system/user prompt. Steps 214 and 216 are repeated again with the new plurality of converted chunks.

A pass status indicates that the verification engine 134 found that the intermediate code [symbol] is within specification and the intermediate code is provided as the target code [symbol] at step 220.

In some implementations, the intermediate code [symbol] is executed to obtain output [symbol] . An expected output [symbol] _{expected} can be compared against the obtained output [symbol] . In some implementations, the expected output [symbol] _{expected} is determined at step 206 as part of the program specifications. If the expected output [symbol] _{expected} is not the same as the obtained output [symbol] , then a feedback [symbol] is generated. In some implementations, the feedback [symbol] ={ [symbol] , TDD artifacts, errors} is generated and provided to the translation engine 130 and/or the large language model 110. The errors can be compile time errors, incorrect values, runtime errors, etc. A simple example of an incorrect value includes a program meant to output today's date instead outputs a hard-coded date from the past. The dates not matching would be an incorrect value that would be pointed out to the large language model 110.

In some implementations, the steps 214 through 216 are repeated for a finite number of iterations. For example, a maximum number of iterations can be provided for the model to converge to a pass status. The maximum number can be 10 iterations, 15 iterations, 35 iterations, 100 iterations, etc. If the maximum number is exceeded, then a copilot mode can be activated where human intervention is requested to correct and refine the intermediate code [symbol] . The client device 104 can be used to modify the next feedback provided to the server 102. For example, the client device 104 can modify the next system/user prompts such that the next feedback provided is { [symbol] , TDD artifacts, user_assessment, errors}, where user_assessment can include instructions to the large language model 110 for fixing or fine-tuning the intermediate code [symbol] .

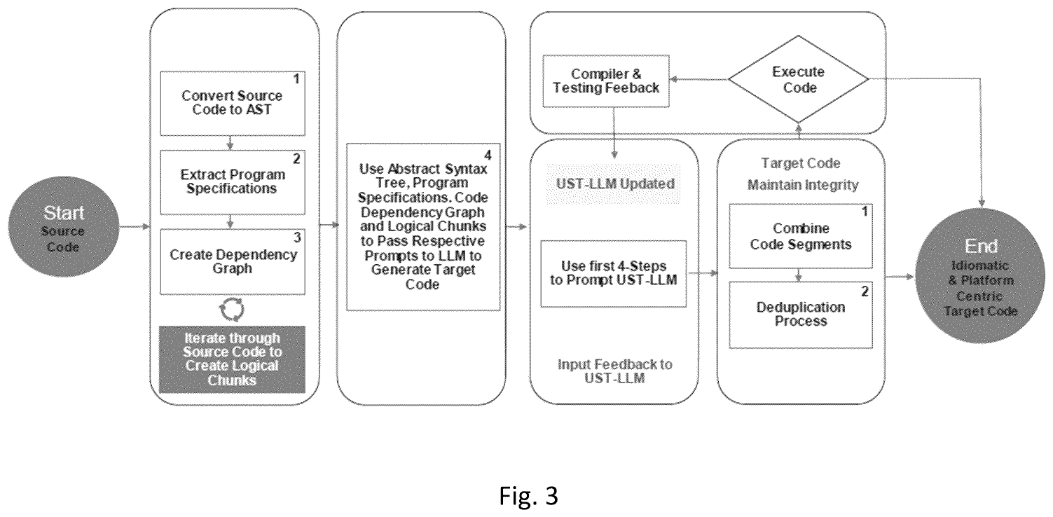

FIG. 3 illustrates a process for translating code from the source code to the target code, according to certain aspects of the present disclosure. FIG. 3 is a different representation of the process 200 of FIG. 2. Starting from source code, a target code can be generated. The target code generated is idiomatic and platform centric to the target language.

In FIG. 3, starting from source code, the source code is converted to an abstract syntax tree. The program specifications are extracted, and a dependency graph is created. The source code is then iterated through to create logical chunks.

The abstract syntax tree, program specification, code dependency graph and logical chunks are used to pass respective prompts to the LLM to generate target code. As provided above, the prompts can include diverse feedback from subject matter experts. The generated target code can be executed to obtain compiler and testing feedback. The feedback can be integrated into a next prompt to generate a next iteration of the target code, as described above with respect to FIG. 2. Idiomatic and platform centric target code is obtained at the end when the final iteration of the target code executes.

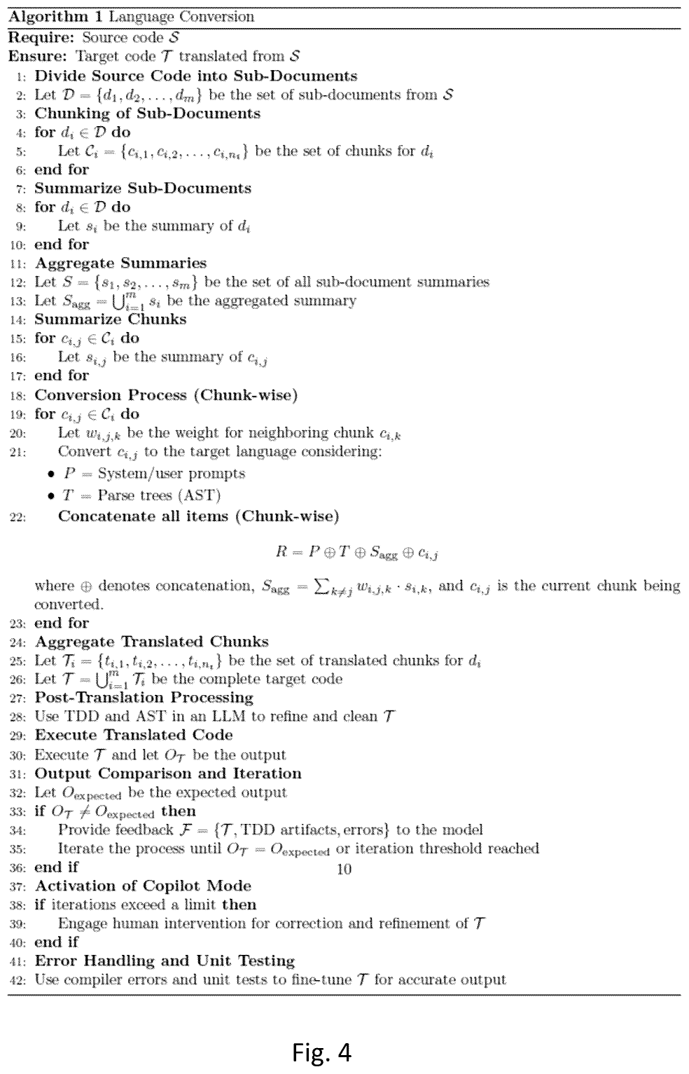

FIG. 4 is an algorithm for language conversion that provides a summary of steps 202 to 220, according to certain aspects of the present disclosure.

Embodiments of the present disclosure can automatically translate source code between diverse programming languages, with a focus on maintaining the functional integrity of the original code. The automatic translation has been shown effective in converting COBOL to Java and BTEQ to PySpark. Such conversions can be invaluable to major corporations that should adeptly manage substantial codebases. Embodiments of the present disclosure integrate various techniques such as abstract syntax trees, code chunking, summarization, and advanced parsing, which collectively fine-tune the code's representation for interpretation by large language models. Such pre-processing prior to the interpretation by large language models ensures that the large language models translate the code with high accuracy. Embodiments of the present disclosure incorporate a feedback loop for iterative refinement based on comparison with the original code's expected results, enhanced by technical documentation, error signals, and output differences. This process, supported by human intervention, allows for precise adjustments in complex scenarios. Embodiments of the present disclosure can create detailed dependency graphs, facilitating the management of large-scale software projects.

In some implementations, self-documented code generation and adherence to target platform architecture are integral to capability of the system 100 in order to produce high-quality, maintainable, and efficiently executable code across different programming languages and platforms. Embodiments of the present disclosure uniquely generates self-documented code as part of the translation process. This entails the production of code that is intrinsically well-commented, with clear explanations of functionality, purpose, and logic flow. It utilizes variable names and parameters that are self-explanatory, significantly reducing the cognitive load on developers when reading or maintaining the code. This feature not only aids in understanding the generated code but also aligns with best practices in software development, fostering better maintainability and scalability of the translated codebase.

In some implementations, a standout feature is the intelligent translation approach, provided in the present disclosure, that respects the architectural nuances and idiomatic patterns of the target platform rather than merely converting code on a line-by-line basis. For instance, when translating from SQL to PySpark, some embodiments produce output that leverages PySpark's distributed data processing capabilities, rather than mimicking SQL syntax in a PySpark environment. This ensures that the translated code is optimized for performance and functionality on the target platform, taking full advantage of its specific features and capabilities. This approach significantly differs from traditional translation methods, which often result in inefficient, non-idiomatic code that fails to utilize the strengths of the target platform.

Empirical evaluation of some implementations of the present disclosure centered on successful deployment in converting COBOL to Java and BTEQ to PySpark for various companies. This task involved processing extensive and complex codebases, and the systems and methods disclosed herein demonstrated adaptability and efficiency in industry-scale environments. Substantial gains in translation fidelity and completeness was achieved compared to existing techniques for code generation.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A system, comprising:
one or more data processors; and
a non-transitory computer-readable storage medium containing instructions which, when executed on the one or more data processors, cause the one or more data processors to perform operations including:
receiving source code for converting to target code, wherein programming language of the source code is different from programming language of the target code,
determining an abstract syntax tree from the source code,
determining program specifications from the source code,
determining a dependency graph from the source code,
determining a plurality of chunks based at least in part on the abstract syntax tree, the program specifications, and the dependency graph,
determining a plurality of converted chunks based at least in part on the plurality of chunks and a deep learning model, the deep learning model converting the plurality of chunks from the programming language of the source code to the programming language of the target code to obtain the plurality of converted chunks,
post-processing the plurality of converted chunks to obtain intermediate code, and
providing the intermediate code as the target code.

2. The system according to claim 1, wherein executing the instructions further cause the one or more data processors to perform the operations including:
determining a status associated with the intermediate code; and
based at least in part on the status indicating a fail status, providing feedback to the deep learning model.

3. The system according to claim 2, wherein executing the instructions further cause the one or more data processors to perform the operations including:
determining that the status is the fail status based on compile time errors, compile time warnings, runtime errors, presence of artifacts in an expected output, or any combination thereof.

4. The system according to claim 2, wherein the determining the status associated with the intermediate code includes:
compiling the intermediate code.

5. The system according to claim 2, wherein the determining the status associated with the intermediate code includes:
executing the intermediate code.

6. The system according to claim 2, wherein executing the instructions further cause the one or more data processors to perform the operations including:
iterating a feedback loop until the status indicates a pass status, the feedback loop including the steps of:
(i) the determining the plurality of converted chunks based at least in part on the plurality of chunks and the deep learning model,
(ii) the post-processing the plurality of converted chunks,
(iii) the determining the status associated with the intermediate code, and
(iv) based at least in part on the status indicating the fail status, the providing feedback to the learning model.

7. The system according to claim 6, wherein executing the instructions further cause the one or more data processors to perform the operations including:
in response to reaching a maximum number of iterations, prompting a client device for a user assessment;
receiving the user assessment from the client device; and
further iterating the feedback loop incorporating the user assessment.

8. The system according to claim 1, wherein determining the plurality of chunks based at least in part on the abstract syntax tree, the program specifications, and the dependency graph includes:
determining the plurality of chunks based on function declarations;
determining the plurality of chunks based on classes;
determining the plurality of chunks based on loop constructs; and/or
determining the plurality of chunks based on files.

9. The system according to claim 1, wherein determining the plurality of chunks based at least in part on the abstract syntax tree, the program specifications, and the dependency graph includes:
traversing the abstract syntax tree to identify nodes corresponding to desired programming constructs.

10. The system according to claim 9, wherein the abstract syntax tree is traversed using a depth-first search strategy or a breath-first search strategy.

11. The system according to claim 9, wherein a subtree is associated with a first node in the identified nodes corresponding to the desired programming constructs, and wherein a first chunk in the plurality of chunks is represented by the first node and the subtree associated with the first node.

12. The system according to claim 1, wherein determining the dependency graph from the source code includes:
performing both static and dynamic analysis on the source code to construct the dependency graph.

13. The system according to claim 1, wherein determining the program specifications from the source code includes:
summarizing at least part of the source code;
determining at least an expected output from running the source code; and/or
determining a running time associated with the source code.

14. The system according to claim 13, wherein the target code includes:
summaries corresponding to at least one of the plurality of chunks.

15. A method comprising:
receiving source code for converting to target code, wherein programming language of the source code is different from programming language of the target code;
determining an abstract syntax tree from the source code;
determining program specifications from the source code;
determining a dependency graph from the source code;
determining a plurality of chunks based at least in part on the abstract syntax tree, the program specifications, and the dependency graph;
determining a plurality of converted chunks based at least in part on the plurality of chunks and a deep learning model, the deep learning model converting the plurality of chunks from the programming language of the source code to the programming language of the target code to obtain the plurality of converted chunks;
post-processing the plurality of converted chunks to obtain intermediate code; and
providing the intermediate code as the target code.

16. The method according to claim 15, further comprising:
determining a status associated with the intermediate code; and
based at least in part on the status indicating a fail status, providing feedback to the deep learning model.

17. The method according to claim 16, further comprising:
determining that the status is the fail status based on compile time errors, compile time warnings, runtime errors, presence of artifacts in an expected output, or any combination thereof.

18. The method according to claim 16, wherein the determining the status associated with the intermediate code includes:
compiling the intermediate code.

19. The system according to claim 16, wherein the determining the status associated with the intermediate code includes:
executing the intermediate code.

20. The method according to claim 16, further comprising:
iterating a feedback loop until the status indicates a pass status, the feedback loop including the steps of:
(i) the determining the plurality of converted chunks based at least in part on the plurality of chunks and the deep learning model,
(ii) the post-processing the plurality of converted chunks,
(iii) the determining the status associated with the intermediate code, and
(iv) based at least in part on the status indicating the fail status, the providing feedback to the learning model.
